(19) United States
(12) Patent Application Publication
(10) Pub. No.: US 2025/0111229 A1
(43) Pub. Date: Apr. 3, 2025

(54) SYSTEMS AND METHODS FOR UNCERTAINTY-AWARE INPUT OPTIMIZATION IN GENERATIVE NEURAL NETWORKS

(71) Applicant: Themis AI, Inc., Cambridge, MA (US)

(72) Inventors: Daniela Rus, Weston, MA (US); Iaroslav Elistratov, Alanya (TR); Fynn Schmitt-Ulms, Cambridge, MA (US); Ege Demir, Bursa (TR); Alejandro Perez, Manchester, NH (US); Elaheh Ahmadi, Encino, CA (US)

(21) Appl. No.: 18/902,107

(22) Filed: Sep. 30, 2024

Related U.S. Application Data
(60) Provisional application No. 63/586,139, filed on Sep. 28, 2023.
(60) Provisional application No. 63/586,185, filed on Sep. 28, 2023.

(51) Int. Cl. G06N 3/08; G06N 3/0475

(52) U.S. Cl. CPC G06N 3/08; G06N 3/0475

(57) ABSTRACT

Methods of modifying an input, such as a prompt, for a machine learning model are disclosed. In at least some instances, the method includes transforming a received user model into a risk-aware model, applying that risk-aware model to a received input, and receiving, based on the application of the risk-aware model, output and corresponding risk values. In turn, the method includes determining whether the corresponding risk values, or an aggregate of such values, are less than a predetermined threshold level. If the values or aggregate are greater than the predetermined threshold level, then a process is performed to modify the input to minimize the corresponding risk values. The risk-aware model is iteratively applied to the modified input and the modification process continues to be performed until the corresponding risk values are less than the predetermined threshold level. Other methods, and systems for performing any methods disclosed, are also provided.

### RELATED APPLICATIONS

The present disclosure claims priority to U.S. Provisional Patent Application No. 63/586,139, entitled “Systems and Methods for Prompt Optimization in Machine Learning,” and U.S. Provisional Patent Application No. 63/586,185, entitled “Systems and Methods for Uncertainty-A ware Learning in Machine Learning,” both of which were filed on Sep. 28, 2023, and both of which are incorporated by reference herein in their entireties.

### TECHNICAL FIELD

This disclosure generally describes devices, systems, and methods related to computer-automated techniques and algorithms for automated prompt engineering and improving robustness and fidelity of generative models.

### BACKGROUND

Some approaches for automated prompt engineering in generative artificial intelligence (AI) models require additional training, use of separate models, access to training data and/or internal state variables, performing tree searches over outputs of the models, and/or incorporation of human feedback for queries that are based on user error correction. These approaches may be limited due to their reliance on the human-engineered constraints and heuristics that may hamper applicability and generalization of such approaches. Further, generative models may be susceptible to failure modes, including but not limited to hallucinations and adversarial attacks. However, general-purpose frameworks for estimating risk in large-scale generative models are lacking. Existing approaches for estimating risk in such models may include estimating a singular form of uncertainty in the context of specific data modalities.

Accordingly, there is a need for techniques that may reliably assess risks in generative models, as well as leverage the risk estimates in critical areas of generative models, including but not limited to identification of failures and optimization of input prompts.

### SUMMARY

The disclosure generally describes technology for improving robustness and fidelity of generative models by modifying and optimizing input prompts to the models. The disclosure describes techniques for generating and propagating risk estimates through at least neural network (NN) models (e.g., inputs, outputs, latent representations), thereby allowing for optimization of input prompts to minimize output risk as well as identification of highly uncertain input and output regions.

More particularly, the disclosed technology may leverage estimated per-token uncertainty values for automated prompt optimization in generative models. Without requiring additional data, training, ensembling, or use of additional models, the disclosed technology improves output quality of the generative models by using risk estimates to guide prompt optimization, thereby guiding the generation process of the model to minimize uncertainty in the prompts. The risk estimates can be used iteratively to refine prompts to improve quality of outputs of the generative model. For example, computer-automated prompt optimization techniques may be implemented to improve an output image quality for any type of generative model by iteratively reducing uncertainty in input prompts. The disclosed technology can be deployed in safety-critical scenarios where in-loop risk estimation can help establish robustness of large-scale generative AI systems.

The disclosed technology also provides for automatically identifying highly uncertain regions in the inputs and the outputs of generative AI models. The disclosed technology may provide scalable, computer-automated techniques to estimate and propagate uncertainty through large generative AI models. Using these techniques, uncertainties associated with modeling processes can be identified, such as highly uncertain output regions of generative AI systems. Such computer-automated techniques may also be leveraged to analyze uncertainties associated with inputs and outputs of the generative AI models to identify potential failure modes of such models.

One embodiment of a method for modifying an input for a generative machine learning model includes receiving a user model and an input, transforming the user model into a risk-aware model, and applying the risk-aware model to the input. The model further includes receiving, based on the applying risk-aware model, output and corresponding risk values, and determining whether the corresponding risk values, or an aggregate thereof, are less than a predetermined threshold level. In response to determining that the corresponding risk values, or aggregate thereof, are greater than the predetermined threshold level, the method also includes performing a process to modify the input to minimize the corresponding risk values. Still further, the method includes iteratively applying the risk-aware model to the modified input and performing the process to modify the input until the corresponding risk values are less than the predetermined threshold level.

The action of performing the process to modify the input to minimize the corresponding risk values can include computing a risk estimate for use in guiding an algorithm used to perform the process to modify the input. In at least some such embodiments, the action of performing the process to modify the input to minimize the corresponding risk values can further include at least one of initializing a current input from the input, defining a set of inputs to be used as base text for the current input, and/or defining a list of operations that are able to be performed on a given input. The aforementioned action can further include receiving a previous input and previously computed risk estimate, and, if the computed risk estimate is higher than the previously computed risk estimate, then the action can also include using the previous input as the current input. Still further, the aforementioned action can further include sampling one or more operations of the defined list of operations to modify the current input.

Alternatively, or additionally, the action of performing the process to modify the input to minimize the corresponding risk values can include computing a gradient of risk indicating a numeric vector of how to modify the input to achieve lower corresponding risk values. The gradient of risk can be computed with respect to an initial state of the input. In at least some embodiments, performing the process can also include applying the gradient of risk to the input to modify the input. The process can also include providing the input, the computed gradient of risk, and modeling conditions to a learned model, and receiving, as output from the learned model, the modified input. The learned model can have been trained to modify at least one of image inputs, video inputs, and/or audio inputs based on respective modeling conditions.

In at least some embodiments, in response to determining that the corresponding risk values, or aggregate thereof, are less than the predetermined threshold level, the method can include returning the model output. The machine learning model can be a generative neural network.

The input can include a sequence of vectors, with each vector representing a token. The input can include an image and/or audio, among other inputs. The action of performing the process to modify the input can include applying a negative gradient of risk to the input. In at least some embodiments, after performing the process to modify the input, the method can also include performing post-processing operations on the modified input.

An embodiment of a method for modifying a prompt for a machine learning model includes receiving a prompt to be inputted to a model, with the model being risk aware to cause the model to generate model output and risk values. The method also includes providing the prompt as input to the model, receiving, based on providing the prompt as input to the model, the model output and the risk values, and determining whether the risk values satisfy one or more criteria. Still further, in response to determining that the risk values satisfy the one or more criteria, the method includes modifying the prompt to minimize the corresponding risk value.

The method can also include iteratively providing the modified prompt to the model and performing the process to modify the prompt until the risk values no longer satisfy the one or more criteria. In at least some embodiments, the action of performing the process to modify the prompt to minimize the corresponding risk value can include computing a risk estimate for use in guiding an algorithm used to perform the process to modify the prompt. For example, the action of performing the process to modify the prompt to minimize the corresponding risk value can include at least one of initializing a current prompt from the prompt, defining a set of prompts to be used as base text for the current prompt, and/or defining a list of operations that are able to be performed on a given prompt. Sill further, the action can include receiving a previous prompt and previously computed risk estimate. If the computed risk estimate is higher than the previously computed risk estimate, then the action can include using the previous prompt as the current prompt. Still further, the method can include sampling one or more operations of the defined list of operations to modify the current prompt.

Alternatively, or additionally, modifying the prompt can include computing a gradient of risk that indicates a numeric vector of how to modify the prompt to achieve lower risk values. The gradient of risk can be computed with respect to an initial state of the prompt. In at least some embodiments, the method can include applying the gradient of risk to the prompt to modify the prompt. The method can include providing the prompt, the computed gradient of risk, and modeling conditions to a learned model, and receiving, as output from the learned model, the modified prompt. In these described methods, the term “input” can be used in place of the word “prompt” as well.

An embodiment of a method for modifying an input for a machine learning model includes receiving model output and corresponding risk values, with the model output and corresponding risk values having been generated by a model in response to receiving user input. The method further includes determining whether the corresponding risk values are less than a predetermined threshold value and, in response to determining that the corresponding risk values are greater than the predetermined threshold value, computing a risk estimate. The method also includes modifying the user input based on the computed risk estimate and returning the modified user input.

The action of modifying the user input based on the computed risk estimate can include iteratively providing the modified input to the model until the corresponding risk values are less than the predetermined threshold value. Alternatively, or additionally, the action of modifying the user input based on the computed risk estimate can include at least one of initializing a current input from the user input, defining a set of inputs to be used as base text for the current input, and/or defining a list of operations that are able to be performed on a given input. The action can further include receiving a previous input and previously computed risk estimate. If the computed risk estimate is higher than the previously computed risk estimate, then the action can include using the previous input as the current input. Still further, the method can include sampling one or more operations of the defined list of operations to modify the current input.

Another embodiment of a method for modifying an input for a machine learning model includes receiving model output and corresponding risk values, with the model output and corresponding risk values having been generated by a model in response to receiving user input. The method further includes determining whether the corresponding risk values are less than a predetermined threshold value and, in response to determining that the corresponding risk values are greater than the predetermined threshold value, computing a gradient of risk. The method also includes modifying the user input based on the computed gradient of risk and returning the modified user input.

The action of returning the modified user input can include iteratively providing the modified input to the model until the corresponding risk values are less than the predetermined threshold value. The gradient of risk can include a numeric vector of how to modify the user input to achieve lower risk values. The gradient of risk can be computed with respect to an initial state of the user input. The action of modifying the user input can include applying the gradient of risk to the user input. Alternatively, or additionally, the action of modifying the user input can include providing the user input, the computed gradient of risk, and modeling conditions to a learned model, and receiving, as output from the learned model, the modified user input.

One embodiment of a system for modifying an input for a machine learning model includes a computer system that comprises one or more processors and memory configured to store instructions that, when executed by the one or more processors, cause the computer system to perform a process. The process includes receiving a user model and an input, transforming the user model into a risk-aware model, and applying the risk-aware model to the input. The process further includes, receiving, based on the applying, model output and corresponding risk values, and determining whether the corresponding risk values are less than a predetermined threshold level. The process also includes, in response to determining that the corresponding risk values are greater than the predetermined threshold level, performing a process to modify the input to minimize the corresponding risk values, and iteratively applying the risk-aware model to the modified input until the corresponding risk values are less than the predetermined threshold level.

The action of performing the process to modify the input to minimize the corresponding risk values that is performed by the computer system can include computing a risk estimate for use in guiding an algorithm used to perform the process to modify the input. Further, in at least some embodiments, the action of performing the process to modify the input to minimize the corresponding risk values that is performed by the computer system can include at least one of initializing a current input from the input, defining a set of inputs to be used as base text for the current input, and/or defining a list of operations that are able to be performed on a given input. The action of performing the process can further include receiving a previous input and previously computed risk estimate, and, if the computed risk estimate is higher than the previously computed risk estimate, then using the previous input as the current input. Still further, the action of performing the process can include sampling one or more operations of the defined list of operations to modify the current input.

In at least some embodiments, the action of performing the process to modify the input to minimize the corresponding risk values can include computing a gradient of risk indicating a numeric vector of how to modify the input to achieve lower corresponding risk values. The gradient of risk can be computed, for example, with respect to an initial state of the input. The action of performing the process to modify the input to minimize the corresponding risk values can include applying the gradient of risk to the input to modify the input. In at least some embodiments, in response to determining that the corresponding risk values are less than the predetermined threshold level, the process performed by the computer system can include returning the model output.

One embodiment of a system for modifying a prompt for a machine learning model includes a computer system that comprises one or more processors and memory configured to store instructions that, when executed by the one or more processors, cause the computer system to perform a process. The process includes receiving a prompt to be inputted to a model, with the model being risk aware to cause the model to generate model output and risk values, and providing the prompt as input to the model. The process further includes, receiving, based on the providing the prompt as input to the model, the model output and the risk values. The process also includes determining whether the risk values satisfy one or more criteria and, in response to determining the risk values satisfy the one or more criteria, modifying the prompt to minimize the corresponding risk value.

The process performed by the computer system can include iteratively providing the modified prompt to the model until the risk values no longer satisfy the one or more criteria. The action of modifying the prompt to minimize the corresponding risk value can include computing a risk estimate for use in guiding an algorithm used to perform the process to modify the input. Alternatively, or additionally, the action of modifying the prompt to minimize the corresponding risk value can include at least one of initializing a current prompt from the prompt, defining a set of prompts to be used as base text for the current prompt, and/or defining a list of operations that are able to be performed on a given prompt. Sill further, the action of modifying the prompt to minimize the corresponding risk value can include receiving a previous prompt and previously computed risk estimate. If the computed risk estimate is higher than the previously computed risk estimate, then the action can include using the previous prompt as the current prompt. Still further, the action of modifying the prompt to minimize the corresponding risk value can include sampling one or more operations of the defined list of operations to modify the current prompt.

In at least some embodiments, modifying the prompt to minimize the corresponding risk value can include computing a gradient of risk that indicates a numeric vector of how to modify the prompt to achieve lower risk values. The gradient of risk can be computed with respect to an initial state of the prompt. The process performed by the computer system can also include applying the gradient of risk to the prompt to modify the prompt. In at least some embodiments, the process performed by the computer system can further include providing the prompt, the computed gradient of risk, and modeling conditions to a learned model, and receiving, as output from the learned model, the modified prompt.

Another embodiment of a system for modifying an input for a machine learning model includes a computer system that comprises one or more processors and memory configured to store instructions that, when executed by the one or more processors, cause the computer system to perform a process. The process includes receiving model output and corresponding risk values, with the model output and corresponding risk values having been generated by a model in response to receiving user input. The process also includes determining whether the corresponding risk values are less than a predetermined threshold value, and, in response to determining that the corresponding risk values are greater than the predetermined threshold value, computing a risk estimate. Still further, the process includes modifying the user input based on the computed risk estimate and returning the modified user input.

The action of returning the modified user input can include iteratively providing the modified input to the model until the corresponding risk values are less than the predetermined threshold value. Alternatively, or additionally, the action of modifying the user input based on the computed risk estimate can include at least one of initializing a current input from the input, defining a set of inputs to be used as base text for the current input, and/or defining a list of operations that are able to be performed on a given input. The action of modifying the user input based on the risk estimate can include receiving a previous input and previously computed risk estimate and, if the computed risk estimate is higher than the previously computed risk estimate, then using the previous input as the current input. Still further, the action of modifying the user input based on the risk estimate can include sampling one or more operations of the defined list of operations to modify the current input.

Still another embodiment of a system for modifying an input for a machine learning model includes a computer system that comprises one or more processors and memory configured to store instructions that, when executed by the one or more processors, cause the computer system to perform a process. The process includes receiving model output and corresponding risk values, with the model output and corresponding risk values having been generated by a model in response to receiving user input. The process also includes determining whether the corresponding risk values are less than a predetermined threshold value, and, in response to determining that the corresponding risk values are greater than the predetermined threshold value, computing a gradient of risk. Still further, the process includes modifying the user input based on the computed gradient of risk and returning the modified user input.

The action of returning the modified user input can include iteratively providing the modified input to the model until the corresponding risk values are less than the predetermined threshold value. The gradient of risk can include a numeric vector of how to modify the input to achieve lower risk values. In at least some embodiments, the gradient or risk can be computed with respect to an initial state of the user input.

Traditionally, computer automated systems may be used to optimize prompts and other inputs to machine learning models. The computer systems may use extensive computational resources, and processing time, because they generally require executing generative models on multiple different prompts to identify which prompt(s) produces preferred output. The traditional process performed by the computer systems is inefficient because the process generally does not have a signal as to which modifications to the prompt will lead to improved output, necessitating numerous prompt variations and model evaluations. Further, the conventional approaches for prompt optimization often rely on hardcoded heuristics. For example, in general, the goal of prompt optimization approaches is to improve quality and fidelity of the generated predictions, however, the traditional approaches approximate this true objective with a process requiring hardcoded logic. The disclosed technology, on the other hand, alleviates or minimizes the above problems.

The disclosure transforms a user model into a risk-aware model, provides an input prompt to the risk-aware model, analyzes risk values generated by the risk-aware model for the particular prompt, and then dynamically and automatically modifies the prompt until a desired level of risk is achieved for that modified prompt. In some implementations, the disclosure reduces the number of iterations required for executing the generative model by computing an exact numeric modification to the prompt which minimizes output risk. Additionally, the disclosed technology is scalable and allows for more generalized prompt optimization. It alleviates a limitation of only supporting the optimization of text prompts by allowing the analysis and modification of any continuous or discrete input.

In some implementations, the disclosed technology can further provide for performing such operations end-to-end in a learned way without requiring human feedback, and/or use of hardcoded heuristics, which results in a more general and a more efficient algorithm. More specifically, some non-limiting exemplary embodiments, as part of modifying a given prompt, can compute gradients of risk with respect to the input prompt, modify the prompt based on the computed gradients of risk, and/or iterate through these operations until the prompt/input is modified sufficiently to achieve a desired risk. Traditionally, the computer systems may not compute the gradient of risk, and instead would rely on user input, hardcoded heuristics, and/or user analysis indicating whether and how the user believed the prompt/input should be modified. This could result in the need to run the model with different prompts multiple times, thereby consuming significant amounts of compute and processing resources. On the other hand, some implementations of the disclosed technology compute the gradient of risk with respect to the prompt as a relatively lightweight and efficient operation not realized by traditional computer processes. This allows for fast and accurate modification of a prompt/input. Instead of iteratively stochastically editing combinations of words in an input prompt trying to find a prompt edit that may reduce output risk, by computing gradient of risk with respect to the prompt, the disclosed technology can directly step in the direction of negative gradient to get closer to having an input prompt that minimizes the output risk.

### BRIEF DESCRIPTION OF THE DRAWINGS

This disclosure will be more fully understood from the following detailed description, taken in conjunction with the accompany drawings, in which:

FIG. 1 is a conceptual diagram of a system for optimizing a prompt for a machine learning model using the disclosed technology;

FIG. 2 is a conceptual diagram of a system that can be used to transform a model into its risk-aware variant to be used with the disclosed technology;

FIG. 3A is a flowchart of a process for optimizing a model prompt using the disclosed technology;

FIGS. 3B and 3B (Cont.) are a flowchart of a process for modifying a model prompt to minimize a corresponding risk value;

FIG. 3C is a flowchart of another illustrative process for modifying a model prompt;

FIG. 4 is an illustrative assessment of token-by-token uncertainty in text prompts for image generation;

FIG. 5 is a table illustrating example images generation before and after applying uncertainty-guided prompt optimization techniques described herein;

FIG. 6 illustrates an example of identification of potential failure modes (e.g., highly uncertain output regions) of a generative neural network model that can be performed using the disclosed technology;

FIG. 7 is a table illustrating example images with high-uncertainty regions from outputs of risk-aware stable diffusion techniques; and

FIG. 8 is a schematic diagram that shows an example of a computing system that can be used to implement the techniques described herein.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Unless otherwise defined, all technical terms used herein have the same meaning as commonly understood by one of ordinary skill in the art to which this disclosure belongs. In the present disclosure, the term “risk” may correspond to any one or more different forms of uncertainty, such as aleatoric uncertainty, epistemic uncertainty, and/or vacuity uncertainty, including one or more combinations thereof. A person skilled in the art, in view of the present disclosure, will appreciate one or more other forms of uncertainty may also be realized and defined as “risk.” In the present disclosure, the terms “input” and “prompt” may be used interchangeably such that use of one is generally inclusive of the other. A person skilled in the art will appreciate the term “prompt” is one example of an “input,” where other inputs may include, for example, images, audio signals, video frames, time series data, latent representations, initial implicit state of the model, and/or any other form of data that can be processed by the model to condition its state and/or its output. Further, in an least some instances, other terms understood by those skilled in the art may be used in lieu of the term “input” or “prompt.” For example, a model designed primarily for an image task, such as an image-to-image translation or inpainting, may use the term “input image” and/or “source image” instead of a term like “input” or “prompt.” Some generative models can have an implicit initial state that is not inputted from or by the user, but rather, is inputted from another source. For example, some models can create a random initial state from which a model starts generating the output (e.g., in generative adversarial networks (GANs), diffusion models, etc.).

This disclosure generally relates to technology for computer-based algorithms and techniques of analysis and processing of output uncertainty of generative neural networks, such as generative models and generative artificial intelligence (AI) models, to enable input optimization of such models and thus minimize the models' output uncertainty. More specifically, the disclosed technology provides for a prompt optimization algorithm that can improve output image quality by reducing uncertainty in respective input prompts. The disclosed technology can estimate per-output uncertainty of models, such as generative models and AI models, and enable optimization of a model's input to minimize the output's uncertainty. The disclosed technology also provides computer-based algorithms and techniques for automatically identifying outputs that likely contain errors (e.g., highly uncertain output regions) to improve robustness of such models. References to generative models herein can be applicable to AI models as well, and more generally to generative neural networks (NNs).

The disclosed technology can apply to any type of input, including but not limited to text prompt input, sound wave frequencies input, image input, etc. Although the disclosed technology is described from the perspective of text prompt optimization, this is merely an illustrative example.

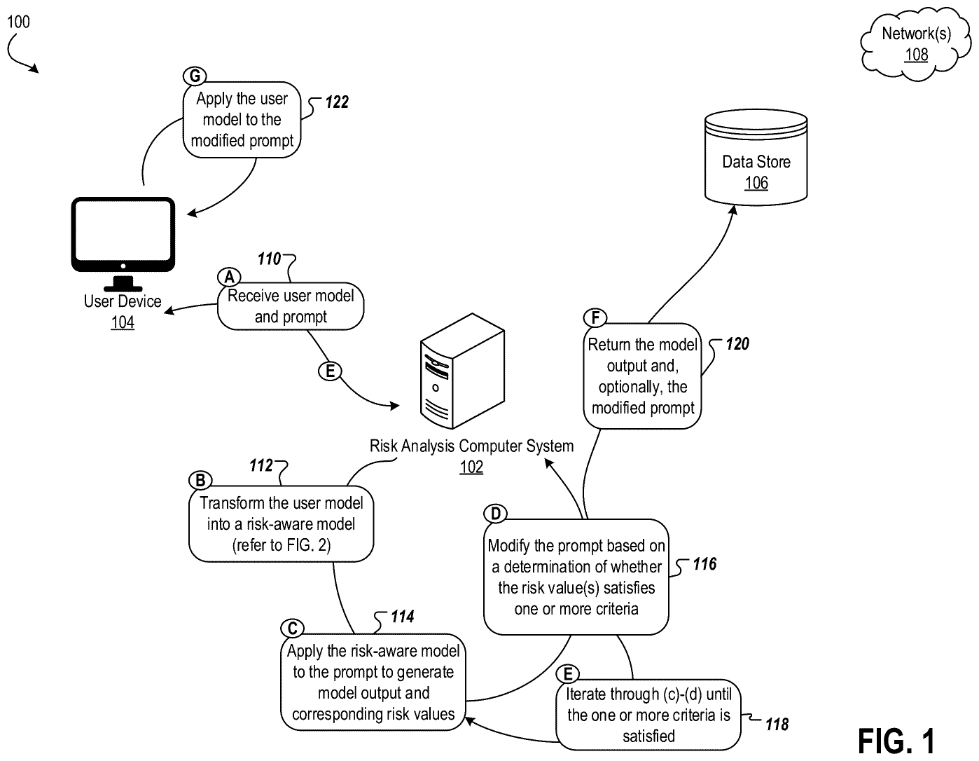

Referring to the figures, FIG. 1 is a conceptual diagram of a system 100 for optimizing a prompt for a machine learning model using the disclosed technology. The system 100 can include a risk analysis computer system 102, which can communicate with a user device 104 and/or a data store 106 over network(s) 108. In some implementations, the user device 104 and/or the data store 106 may be part of the computer system 102. Sometimes, one or more of the user device 104 and the data store 106 may be separate systems from the computer system 102 and/or remote from the computer system 102. The computer system 102 can be configured to execute software modules, engines, and/or instructions for performing the disclosed techniques.

The computer system 102 can receive a user model and a prompt in block A (110). The user model and the prompt can be received at different times and/or in separate instances. The prompt can be any type of data modality, including but not limited to text, audio, images, and/or video, and others. The prompt can refer to an initial state that guides a model, such as a generative model or an AI model, in generating a response. The prompt serves as the starting point for the model to produce relevant and coherent output.

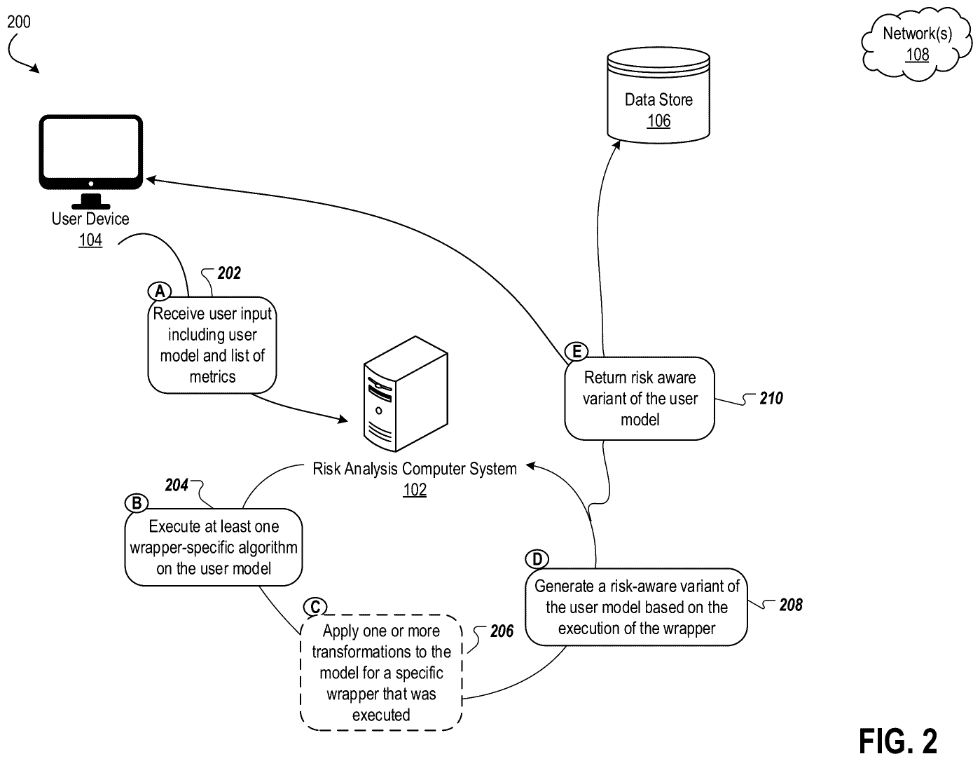

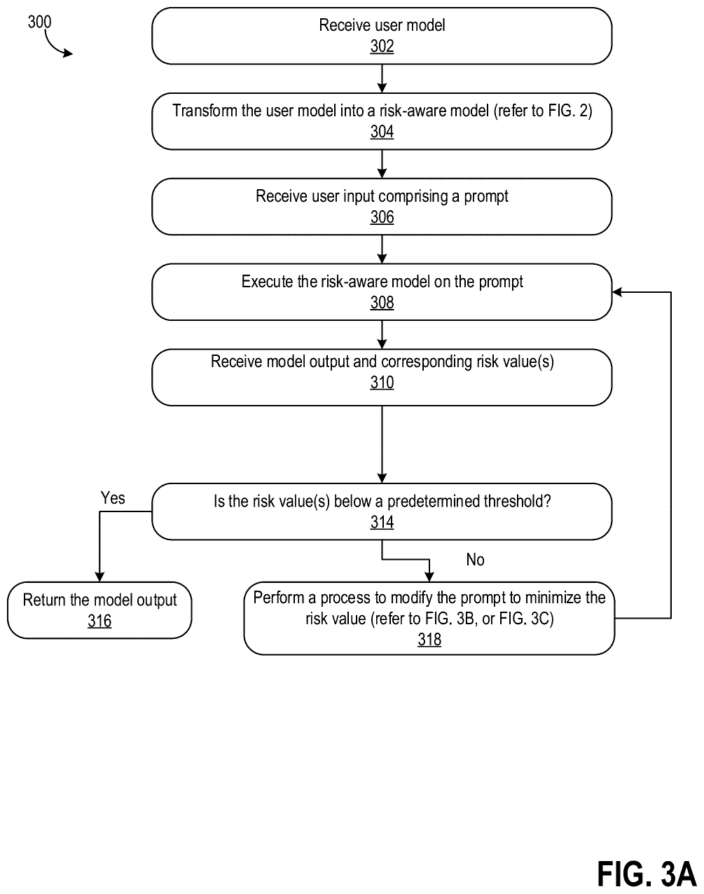

The computer system 102 can transform the user model into a risk-aware variant of the model, as described further in reference to FIG. 2 (block B, 112).

In block C (114), the computer system 102 can apply the risk-aware model to the prompt to generate model output and corresponding risk values, as described further below.

Modifying the prompt can change the quality of the output generated by the user model. The disclosed technology can be applied to improve the quality of generated outputs by iteratively reducing uncertainty in the respective input prompts. Accordingly, the computer system 102 can modify the prompt based on a determination of whether the risk value(s) satisfies one or more criteria (block D, 116).

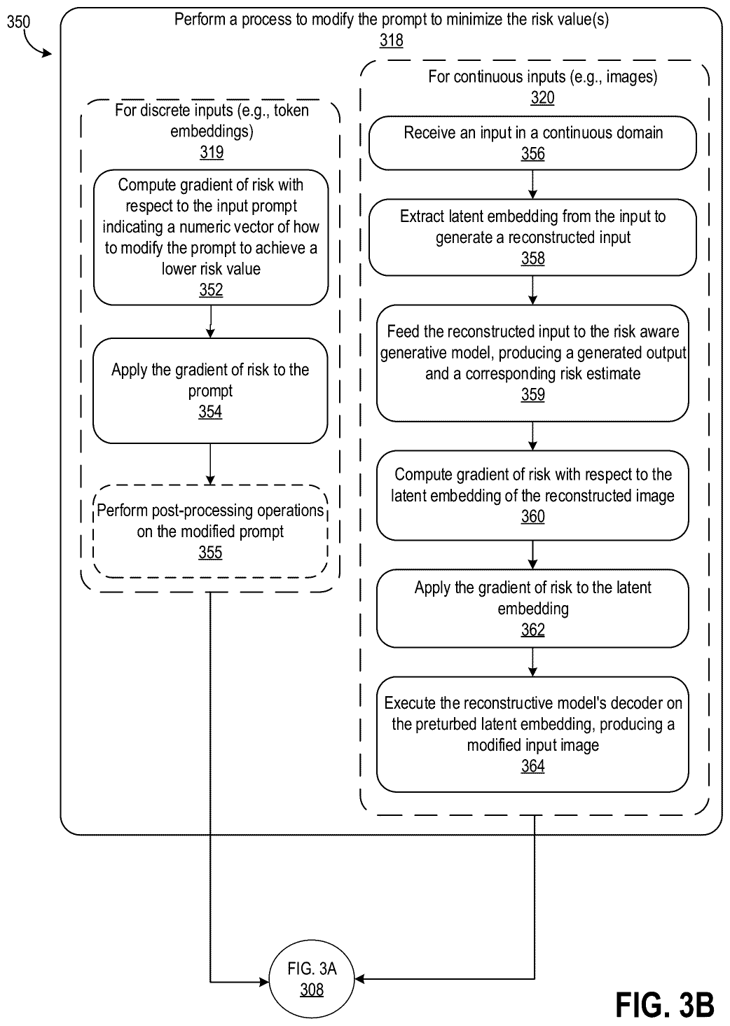

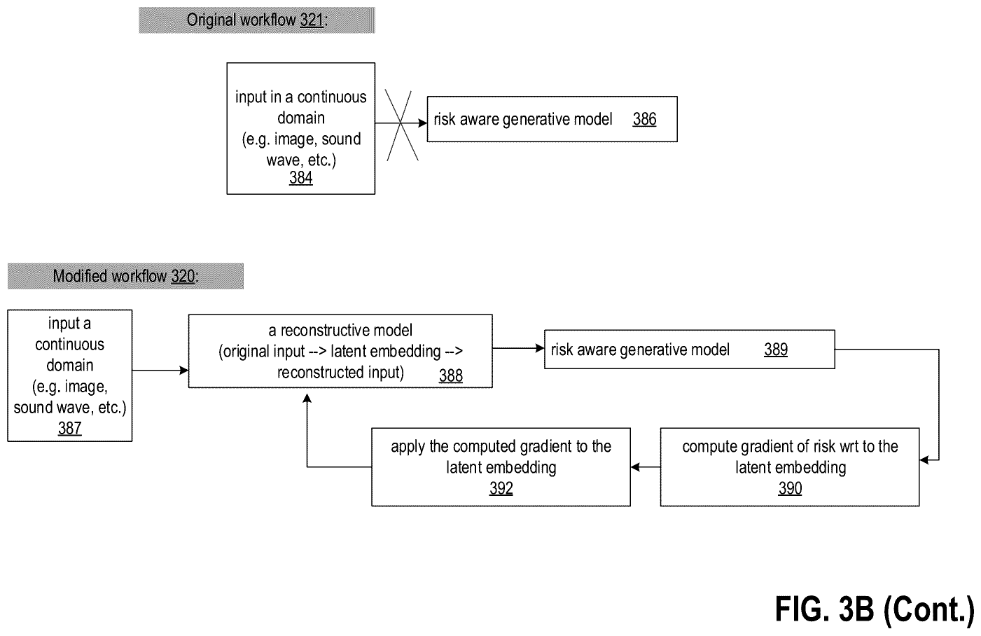

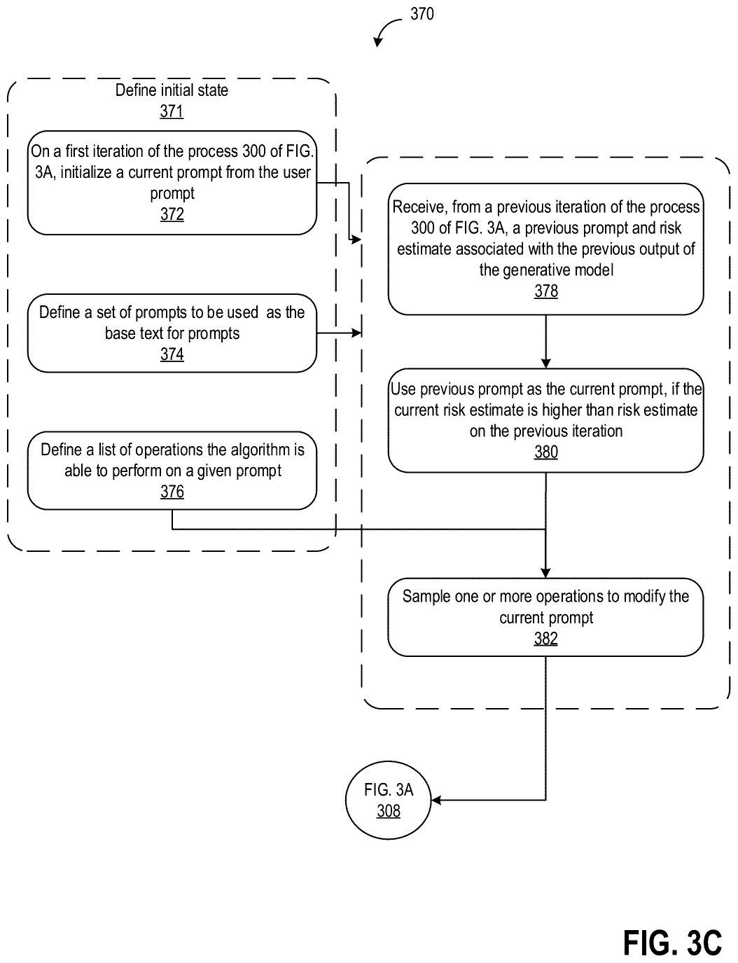

In some implementations, the computed risk value(s) can be used to compute gradient of risk with respect to the input prompt, which can be used to numerically transform the prompt to minimize the corresponding risk value(s). Gradient can be a vector of partial derivatives that represent a direction and rate of fastest increase of a function. Applying the scaled negative gradient to the input prompt can allow for minimizing the corresponding output risk by changing the input vectors (which were originally representing the input prompt). Conventional systems may compute gradient of loss with respect to weights (i.e., model parameters). Unlike the conventional systems, the computer system 102 described herein computes the gradient of risk with respect to the input prompt, which can numerically indicate exactly how to transform the input prompt to minimize the corresponding risk. In some implementations, one or more constraints can be applied to prevent mode collapse, as described further in reference to FIG. 3A.

In some implementations, the gradient of risk may not be used and instead the risk estimates can be used directly to guide an editing algorithm in modifying the prompts. In some illustrative examples, this disclosure may rely on the risk estimate but may not make assumptions as to what prompt editing algorithm can be used, and therefore generalizes to any such algorithm. As one example, a list of operations can be defined, which the algorithm is able to perform on a given prompt (e.g., sample and remove one word, change the location of a word within a prompt, replace a word with a synonym, etc.). Then the risk aware generative model can be used to evaluate each prompt, using its output uncertainty as an evaluation metric. The procedure can iterate, for example, as a Monte Carlo Tree Search. As yet another independent example, instead of using the heuristics-based algorithm described above, a deep learning (DL) model can be trained to predict a modified prompt, which minimizes output risk.

The one or more criteria referenced above (block D, 116) can include a risk value threshold in some implementations. Depending on the risk estimation algorithm, the output risk value(s) can indicate, for example, whether a prompt/input may be out of distribution. A lower output risk value, for example, can indicate that the model has been trained on similar inputs before (in distribution, ID). In other words, the model is expected to generalize to the provided input and produce high quality outputs as a result of the input. The input prompt may not be modified if the risk value is low enough to satisfy the one or more criteria. Lower risk estimate can be desired as it indicates that the model is expected to produce a high quality answer. More particularly, depending on the risk type, a lower risk estimate, for example, can indicate that the input is ID as opposed to out of distribution (OOD).

On the other hand, if the risk value does not satisfy the one or more criteria (e.g., the risk value is greater than a predetermined threshold), then the input prompt can be modified or otherwise optimized to minimize that risk. Refer to FIGS. 3A and 3B for further discussion about modifying the prompt.

The computer system 102 can iterate through blocks C (114) and D (116) until the one or more criteria is satisfied (block E, 118). In other words, once the prompt is modified, the modified prompt can be fed back into the risk-aware model, the model can generate output and corresponding risk value(s), and those risk value(s) can be analyzed by the computer system 102 to determine whether the modified prompt resulted in risk value(s) that satisfies the one or more criteria (e.g., is less than the predetermined threshold). Sometimes, the computer system 102 can iterate through blocks C (114) and D (116) a predetermined amount of times.

The computer system 102 can, in turn, return the generated output and, optionally, the modified prompt in block F (120). The modified prompt can be returned to the user device 104. The modified prompt can be stored at the data store 106.

The user device 104 can apply the user model to the modified prompt (block G, 122) to generate optimized output.

FIG. 2 is a conceptual diagram of a system 200 that can be used to transform a model into a risk-aware variant of the model to be used with the disclosed technology. One or more operations described herein for transforming the model into the risk-aware variant are described further in U.S. application Ser. No. 18/478,301, entitled “Systems and Methods for Automated Risk Assessment in Machine Learning,” filed on Sep. 29, 2023, which is incorporated herein in reference in its entirety. The illustrative system 200 can include the risk analysis computer system 102 described herein. In some implementations, the system 200 can include any other computing system, network of computing devices, and/or cloud-based system. For illustrative purposes, the operations described in reference to the system 200 of FIG. 2 are described from the perspective of the risk analysis computer system 102.

In the example system 200, user input, including an arbitrary user model and list of metrics, can be received from the user device 104 (block A, 202) at the risk analysis computer system 102. The user input can include an original user model, and the original user model can include at least a model architecture.

The computer system 102 may then execute at least one wrapper-specific algorithm to generate a risk aware variant of the user model (block B, 204). For example, the computer system 102 can apply one or more model modifications to the model. As another example, the computer system 102 can apply one or more model augmentations to the modified model. As yet another optional example, the computer system 102 can apply a loss function modified to the augmented and/or modified model. These applications can occur as standalone wrapper operations, or multiple applications can occur in the same risk aware variant analysis.

In some implementations, the computer system 102 can optionally apply one or more other transformations, such as search, add, delete, and/or replace transformations, to the model for a specific wrapper that was executed (block D, 208). The search transformations can include, for example, automatically searching through the model and identifying specific instances of locations/computational operations in the model that can be transformed. Multiple criteria can be used to identify what parts of the model need to be transformed. Another criterion can be based on understanding what specific transformations each wrapper needs to apply. Accordingly, the transformations described herein can be represented as modifications of the model's computational graph without modifying actual user code that generated the model. As an illustrative example, a transformation to represent algorithmically may be an insertion of a mathematical operation in the graph representing the user model. Because the original model is received as input, the computer system 102 can identify what mathematical operations the model computes. The computer system may narrow down possible places in the model that are fit for inserting a new mathematical operation. For example, for each wrapper, a set of mathematical operations in the graph that the computer system needs to search for can be identified and if the computer system finds these operations, the computer system may insert the new mathematical operation after that found operation.

Any transformations of a user model inside a wrapper can be performed as described above in reference to searching components inside that model and inserting/deleting/replacing these components. The one or more model components can include at least one of: (i) one or more mathematical operations performed by the original model; (ii) subgraphs of the one or more mathematical operations, the subgraphs being one or more respective mathematical operations; and/or (iii) one or more groups of the subgraphs.

As part of applying transformations, the computer system 102 can add one or more mathematical operations to the model in one or more places that are specific to a particular wrapper. The computer system may automatically transform the model into its risk aware variant, by applying a wrapper to it. The wrapper can determine: (i) which operation or set of operations (groups of mathematical, computational operations) to add, remove, and/or replace; and (ii) what location(s) in the model to make the addition, removal, and/or replacement. An epistemic wrapper, for example, can be configured to receive a user model and transform that model by, for example, automatically adding one or more probabilistic layers (e.g., a group of mathematical operations that represent a probabilistic layer). The wrapper may also be configured to run the original and/or modified model T times to accurately calculate the uncertainty. By way of non-limiting examples, any of the augmentations may include adding to the model (or to the original model) groups of model components whose outputs may predict standard deviations of ground truth labels (e.g., in addition to predicting the ground truth labels themselves). Such augmentations may include adding one or more model components after each model component of a particular type (and/or by any other criteria), and/or to a group or groups of layers of the original model (e.g., subgraphs of nodes in the computational graph representing the model).

Subsequently, the computer system 102 can return the risk-aware variant of the user model (block E, 210). The risk-aware variant of the user model may further be trained and executed to generate and output one or more risk factors associated with the user model. For example, the computer system 102 can determine representation bias, epistemic uncertainty, aleatoric uncertainty, any combination thereof, and/or other types of risk factors/categories (which can be defined by the user's list of metrics in at least some implementations). The computer system 102 can store the risk factors and/or the risk aware variant more generally in the data store 106 and in association with the original user model (e.g., using a unique identifier/ID that corresponds to and identifies the original user model). The computer system 102 can transmit the risk factors and/or the risk aware variant to the user device 104 for presentation at the device to a relevant user. The computer system 102 can also generate and return one or more recommendations for adjusting the original user model. Such recommendations can be stored in the data store 106 and/or transmitted to the relevant user device 104. As described further below, the risk factors and/or the risk aware variant may further be used by the computer system 102 to perform the disclosed techniques, such as identifying sub-optimal nodes or combinations of operations in the model and/or optimizing one or more of those nodes and/or combinations of operations.

FIG. 3A is a flowchart of a process 300 for optimizing a model prompt using the disclosed technology. The process 300 can be performed by the computer system 102 described herein. The process 300 can also be performed by any other type of computing system, network of computing devices, computing device, and/or cloud-based system. For illustrative purposes, the process 300 is described from the perspective of a computer system.

Referring to the process 300 of FIG. 3A, the computer system can receive a user model in block 302.

The computer system can transform the user model into a risk-aware model in block 304. Refer to FIG. 2 for further discussion.

In block 306, the computer system can receive user input comprising a prompt. In some implementations, the input prompt can be an initial state, such as a sequence of vectors where each vector represents a token. The input prompt can also be an image, audio, or any other type of input.

The computer system can execute the risk-aware model on the prompt in block 308.

Accordingly, the computer system can receive model output and corresponding risk value(s) in block 310, produced by the risk aware model. The risk aware model generates a risk estimate for each output (e.g., for NLP, each output can be a numeric vector representing a token; for image generation, each output can be a pixel). Per-token uncertainties can be used directly. Additionally or alternatively, the per-token uncertainty values can be aggregated into a single score, or set of scores, representing combined risk for the entire output. The aggregation can be a sum, average, and/or max function, although other aggregation functions can also be used. The aggregation can, in at least one or more implementations, be a complex calculation, which can include some combination or aggregation of both the risk scores and the original model outputs.

The computer system can determine whether the risk value(s) is below a predetermined threshold in block 314. The threshold can be calculated, for example, by executing the model on a set of prompts and determining uncertainties for each output token, then computing a value at a predetermined percentile (e.g., 95^{th} percentile). If, during later invocations of the model on other prompts, the output has a higher risk value than that threshold, the prompt should be modified, and therefore the computer system proceeds to block 318; otherwise the computer system proceeds to block 316.

If the risk value(s) is below the predetermined threshold, then the computer system can return the model output (block 316). In other words, low values for one or more risk estimates associated with the model output suggest that the model generalizes to the given input prompt and can indicate a higher quality of the model output(s).

If the risk value(s) is above the predetermined threshold, then the computer system can perform a process to modify the prompt to minimize the risk value(s) (block 318). High risk estimates generally indicate poor quality of the generated model output. Refer to FIGS. 3B and 3C for further discussion about the modification process.

The present description provides at least two separate and independent possible instantiations/implementations of the disclosed techniques. These examples are non-limiting. Fundamentally, the two separate instantiations are different in how they use the risk to modify the prompt. Approach #1 uses gradients of risk (see FIG. 3B and the accompanying descriptions herein), while Approach #2 uses a defined set of manipulations, which an algorithm can perform on the prompt and uses risk estimates to guide that algorithm (see FIG. 3C and the accompany description herein). Presently, Approach #1 has been the focus, with Approach #2 mentioned to a lesser extent. Additional portions of the disclosure below, however, demonstrate Approach #2 is of a similar value or importance as Approach #1. Regardless, these are just two non-limiting examples of possible implementations of the present disclosure, such approaches being unified that they both use risk values to modify prompts.

The disclosure provides a general framework for utilizing risk estimates to guide the process of prompt optimization. The disclosure may not make assumptions as to how specifically risk values can be used to modify a prompt, and therefore generalizes to any such algorithm. Two non-limiting exemplary embodiments of the disclosure are described below with regards to FIGS. 3B and 3C. Both fall within the scope of the present disclosure because each of them uses risk estimates to guide the prompt optimization process. Both can be used in reference to block 318 in the process 300 of FIG. 3A.

As shown and described in reference to FIG. 3B, the computer system can compute a gradient of risk with respect to the input prompt. The computer system can iteratively adjust the prompt by applying scaled negative gradient of risk with respect to the prompt, in some implementations. The computer system can then return to block 308 and iterate through the process 300 until the risk value(s) from using the modified input is below the predetermined threshold. So long as the resulting risk value(s) is above the predetermined threshold, the computer system can iterate through blocks 308-318 of the process 300 a predetermined or unlimited amount of times. The number of iterations can be determined heuristically and/or in a learned way. For example, a lightweight multilayer perceptron (MLP) can be trained to predict the number of iterations required to achieve the optimal modified prompt as indicated by the output risk, which can avoid redundant computations.

FIG. 3B is a flowchart of a process 350 for modifying a model prompt to minimize a corresponding risk value. The process 350 can be performed as part of block 318 in the process 300. The process 350 can be performed by the computer system 102 described herein. The process 350 can also be performed by any other type of computing system, network of computing devices, computing device, and/or cloud-based system. For illustrative purposes, the process 350 is described from the perspective of a computer system.

Referring to the process 350 in FIG. 3B, the computer system can perform a process to modify the prompt to minimize the risk value (block 318). The computer system can perform the process for discrete inputs (e.g., token embeddings) in block 319. In some implementations, the computer system can perform the process for continuous inputs (e.g., images) in block 320.

Referring to performing the process for discrete inputs in block 319, the computer system can compute a gradient of risk with respect to the input prompt indicating a numeric vector of how to modify the prompt to achieve a lower risk value (block 352). In this example, the negative gradient, determined by mathematical derivation through a computational graph representing the user model, can indicate how to adjust the input prompt numerically to reduce output risk.

After computing the gradient of risk, the computer system proceeds to block 354. In block 354, the computer system can apply the gradient of risk to the prompt to modify the prompt. This operation can be performed by subtracting the matrix of partial derivatives (of risk with respect to the input embeddings, representing the original input prompt) from the input matrix containing token embedding vectors.

In block 355, the computer system can optionally perform post-processing operations on the modified prompt. For optimization tasks where model inputs belong to a set of discrete objects, a post-processing step can be used. For example, for NLP a set of tokens in a vocabulary can be mapped into vector space via an embedding layer. After stepping into the opposite direction of gradient with respect to risk (block 354), the perturbed input (e.g., token embeddings after applying the gradient) may not map directly to embeddings of any tokens, but may be somewhere in-between, meaning the perturbed input cannot be easily decoded. This can be remedied, for example, by applying one or more post-processing steps (block 355) after applying the gradient with respect to risk (block 354). This may include, but is not limited to, quantizing perturbed embeddings, for example, mapping each of the perturbed embeddings to the nearest embedding of the known tokens (e.g., as defined by the cosine distance). That is, such techniques can include snapping each of the perturbed embeddings to the closest embedding for a given token. This allows for mapping of the changed vectors to discrete tokens in the original vocabulary.

Alternatively, for generative models that condition on input of other continuous modalities (e.g., image prompt, audio prompt, video prompt, etc.), equivalently, the perturbed input (after the gradient operation in block 354) may not map directly to a meaningful data sample in that modality. More specifically, when the inputs are inherently continuous and do not represent a discrete value for example image prompts, subtracting the gradient of risk from the values representing the image directly in the pixel space can result in an invalid (e.g., blurry) image. The process of block 320 can be performed by the computer system to remedy this problem. The main approach behind the process of block 320 is to apply the gradient of risk in the latent space instead of directly in the domain of the user input (e.g., pixel space).

To that end, the user input prompt (belonging to a continuous domain) can be received in block 356. The user input prompt can include, but is not limited to, images, time series data, and/or sound waves.

The computer system can extract a latent embedding from the received input in block 358. For example, a reconstructive model can be used to produce a latent embedding of the user input. The model can be made to collapse its input into a lower dimensional latent representation and use that representation to reconstruct back its input (e.g., autoencoder (AE)-like architecture). The model can be trained, for example, by penalizing Mean Squared Error (MSE) between the original and the reconstructed input. Other NN architectures can be used in block 358 to learn a latent representation of the user prompt (e.g., generative adversarial networks (GAN), diffusion models, etc.).

Next, the risk aware generative model can be executed on the reconstructed input, producing a generated output and a corresponding risk estimate (block 359). Given this risk estimate, the gradient of risk can be computed with respect to the latent embedding of the reconstructed input (block 360). The gradient of risk can be applied to the latent embedding (block 362).

The computer system can then execute the decoder of the reconstructive model on the perturbed latent embedding to produce a modified input (block 364). That is, the decoder of the reconstructive model (used in block 358) can be executed on the perturbed (after the gradient step) latent embedding, resulting in a modified user prompt. This modified prompt, when fed to the generative model in block 308 of the process 300 described in reference to FIG. 3A, can result in a lower risk output of that generative model.

Additionally, computing gradient of risk with respect to the input prompt can also allow for visualizing the model's risk in the input, which can be useful, for example, in cases where input and output risk may be of different shapes and thus it may not be possible to simply overlay the output risk on the input.

After receiving the modified prompt as output from the model in either blocks 319 or 320, the computer system returns to block 308 of the process 300 described in reference to FIG. 3A.

FIG. 3B (Cont.) provides another illustrative diagram of the process 320, compared to an original workflow 321. The original workflow 321 can include feeding an input (e.g., an image, sound wave, etc.) to a generative model (blocks 384 and 386). To apply a computed gradient in the embedding space, instead of the original domain (e.g., pixel space), the modified workflow 320 provides an alternative approach. In the workflow 320, the connection between the input and the generative model in the original workflow 320 (blocks 384 and 386) is severed and replaced with a reconstructive model (block 388) (e.g., an AE-like architecture), which allows access to latent embedding of the input (block 387). The reconstructed input can be fed to the generative model (block 389), allowing the model to subsequently compute gradient of output risk with respect to the latent embedding for the image (block 390). The computed gradient can be applied to the latent embedding (block 392). To get the modified prompt in the original domain (e.g., pixel space), the perturbed input embedding can be fed through the decoder of the reconstructive model, resulting in an edited input (e.g., the decoder produces an edited image rather than the original image because the decoder of the reconstructive model was executed on the perturbed latent embedding of the original image and not on the latent embedding of the original image). The resulting edited input can correspond to a modified prompt for the generative model. When this modified prompt is fed to the generative model in block 308 of the process 300 described in reference to FIG. 3A, it can result in a lower risk output of that generative model.

FIG. 3C illustrates another exemplary process 370 for modifying a prompt. The process 370 can be a non-gradient based technique for optimizing the prompt to minimize the corresponding risk. The process 370 can use a set of defined discrete manipulations, which the computer system described herein can perform on a prompt, then utilize risk estimates to guide this exemplary prompt editing algorithm, as further described below.

On a first iteration of the process 300 of FIG. 3A, the computer system can define an initial state (block 371). For example, the computer system described herein can initialize a current prompt from the user prompt (block 372). The computer system can also define a set of prompts to be used as base text for the current prompt (block 374). As an illustrative example, a number of brief descriptions of a desired output image can be used as the base text for prompts. The computer system can also define a list of operations that can be performed on a given prompt (block 376). These operations can include, by way of non-limiting examples: sample and remove one word; change location of a word within a prompt; replace a word with a synonym; and add a word from the base text. Blocks 372, 374, and 376 can be performed in any order. Sometimes the blocks 372, 374, and/or 376 can be performed in series, while sometimes the blocks 372, 374, and/or 376 can be performed in parallel.

The computer system can also receive, from a previous iteration of the process 300 of FIG. 3A, the previous prompt and the risk estimate associated with the previous output of the generative model (block 378). Refer to block 308 in the process 300 of FIG. 3A for further discussion. Accordingly, the computer system can use the previous prompt as the current prompt, assuming that the current risk estimate is higher than the risk estimate on the previous iteration (block 380).

Then, using the list of operations that was defined in block 376, the computer system can sample one or more operations to modify the current prompt in block 382. For example, an uncertainty-aware text encoder can be used to evaluate each prompt, using its output uncertainty as the metric. This technique can iterate as a Monte Carlo Tree Search algorithm with branch-and-bound. That is, each prompt can be a state in a tree. During each iteration, a state can be sampled along with one operation used to modify it. The output uncertainty after the modification can be evaluated and the disclosed techniques can be used to add new states to the tree if they result in lower uncertainty estimates (e.g., uncertainty estimates below a predetermined threshold level or value).

Once the prompt has been modified, the computer system can return to block 308 in the process 300 of FIG. 3A.

Using the techniques described above, the computer system (described in reference to FIG. 3C, as part of the process 300) can combine words in the base text descriptions to form prompts that lead to lower uncertainty estimates for the text encoder, resemble prompts created by prompt engineers, and lead to realistic, high-quality images depicting what is described in the text.

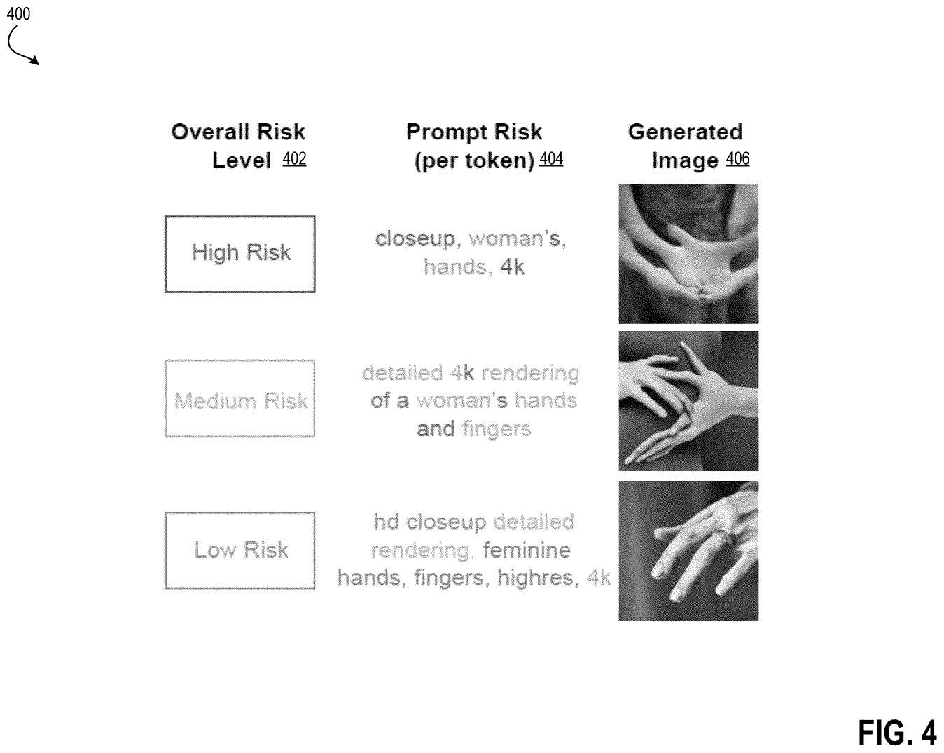

The following FIGS. 4, 5, and 6 illustrate exemplary modified prompts and corresponding outputs of the generative models, which can be achieved with either techniques described in reference to FIGS. 3B and/or 3C.

FIG. 4 is an illustrative assessment 400 of token-by-token uncertainty in text prompts for image generation. A latent text-to-image diffusion model, such as a Stable Diffusion model, can be used. An image generator can contain three main models that the disclosure individually estimates and propagates uncertainty through. The model can also include a text encoder that takes in prompts as input, the diffusion model used to generate latents over multiple steps, and an autoencoder decoder, which converts latents into images. Although particular model architectures are described herein, the disclosed technology can be applied to any model architecture (as described earlier in reference to FIG. 2). The model can be transformed into its risk-aware variant, as described herein. The text encoder can be converted into its risk-aware variant and utilize, for example, one of the algorithms above (as described in reference to FIGS. 3B, 3B (Cont.), and/or 3C) to consider the output uncertainty of the text encoder itself to optimize a prompt.

Individual prompts can be evaluated for overall uncertainty (overall risk level 402) and per-token uncertainty (prompt risk per token 404). Varying levels of uncertainty result in varying levels of fidelity in generated images (generated image 406). Using uncertainty-aware text encoding techniques disclosed herein, such as those provided for below or otherwise described herein, uncertainties can be calculated over individual tokens to visualize relative uncertainty across prompts. Using generation of human hands as an illustrative example, FIG. 4 illustrates that the prompts with greater overall and per-token uncertainty resulted in poorer generations. Empirically, more specific components to a prompt (e.g., “closeup,” “feminine hands,” “highres”) can improve the fidelity of the generated image.

The relationship between per-token uncertainty and the quality of the image output shown and described in reference to FIG. 4 indicates that uncertainty-guided prompt optimization can improve outputs of a generative model. A model or algorithm, as described herein, can therefore leverage estimated per-token uncertainty for prompt optimization. The algorithm (or model) can be deployed over a series of example prompts in order to optimize them, as shown by the illustrative results of the table 500. At regular intervals in the optimization process, the resulting prompts can be leveraged as input to the risk-aware model, for example, a stable diffusion model described in FIG. 4 to generate samples and then evaluate quality of image generations as a function of prompt tuning.

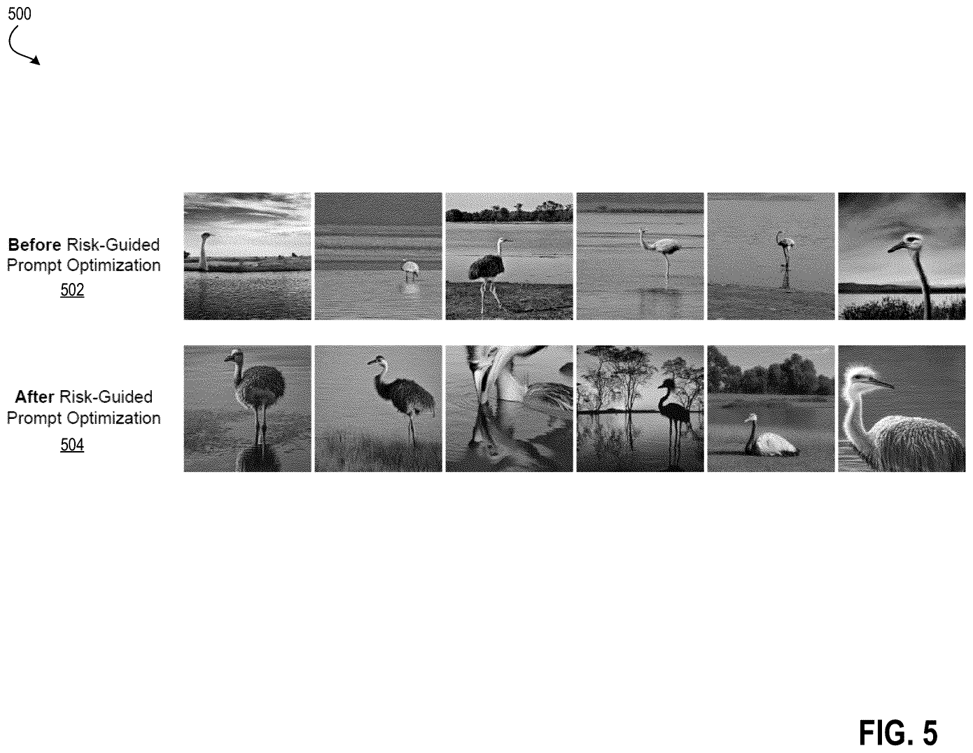

FIG. 5 is a table 500 illustrating example images generated before (502) and after (504) applying uncertainty-guided prompt optimization techniques described herein. The top row 502 of the table 500 illustrates images generated using an original illustrative prompt: “an ostrich by a lake” before the disclosed risk-guided prompt optimization techniques are applied. The bottom row 504 of the table 500 illustrates images generated after optimizing input prompts to minimize their own uncertainty using the disclosed risk-guided prompt optimization techniques, the prompts being of high fidelity and quality. By optimizing prompts to minimize their uncertainty, as shown by the row 504 of the table 500, downstream generated image quality can be improved without the need to manually perform hand-engineered prompt tuning (e.g., by using the process described in FIGS. 3B and 3B (Cont.)). As shown, the disclosed uncertainty-guided prompt optimization techniques led to a significant improvement in quality of generations relative to a naive, un-optimized base prompt. These results demonstrate that the estimated uncertainties from the disclosed risk-aware generative model can be deployed successfully for in-the-loop uncertainty-guided prompt optimization, thereby yielding image generations of greater robustness and fidelity.

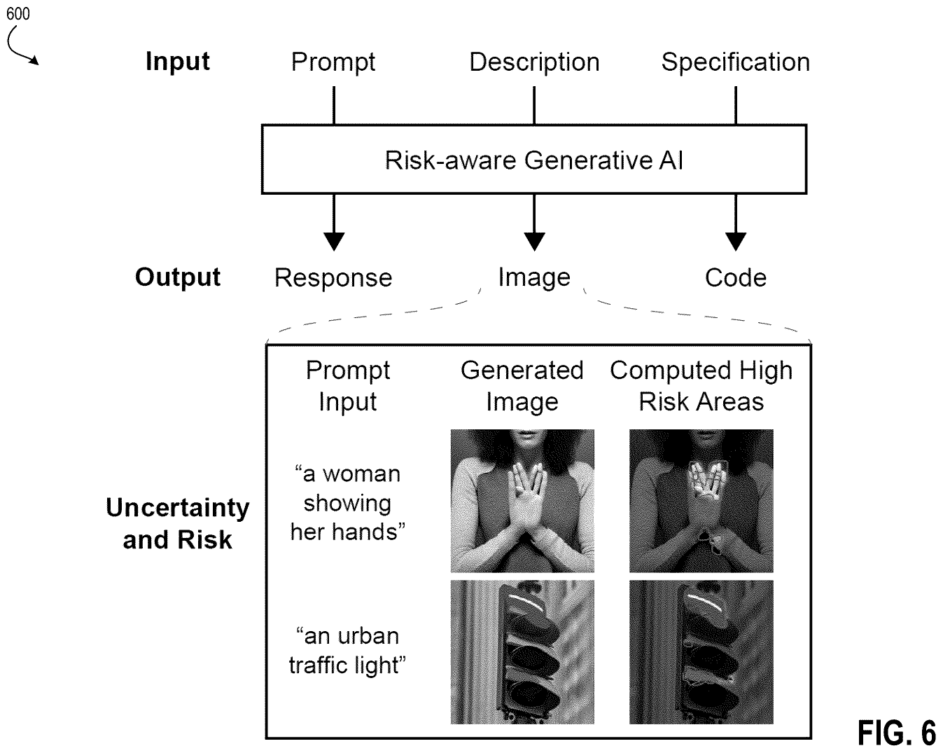

FIG. 6 illustrates example risk-aware image generation 600 that can be performed using the disclosed technology. The techniques described above can be applied to create an uncertainty-aware variant of the illustrative Stable Diffusion text-to-image model described in reference to FIGS. 4 and 5, thereby allowing for the estimation and propagation of uncertainty over inputs, latent representations, and/or outputs. The disclosed techniques further allow for identification of uncertain output regions and can be deployed in robust and auditable generative AI systems. Accordingly, the disclosed technology provides a scalable method for estimating and propagating uncertainty through large generative AI models to uncover and diagnose various issues that may arise during deployment.

In the example image generation 600 of FIG. 6, by endowing generative models with uncertainty-aware capabilities, highly uncertain output regions can be identified automatically and accurately. Such results can provide principled insights into challenging aspects in generative AI deployment. The disclosed technology can be used to estimate per-output risk of generative models and automatically identify outputs that are likely containing errors, as indicated by their high predicted risk values. Such techniques, optionally, can visualize an estimated risk alongside original outputs, allowing to easily and effectively interpret the model's predictions together with their associated risk values. The disclosed technology can generalize beyond any specific input/output representation of generative models (e.g., tokens for text generation, frequencies for audio generation, frames for video generation, etc.), and can be similarly used to identify areas that likely contain errors.

An example model used in the image generation 600 of FIG. 6 can be the stable diffusion model described in reference to FIGS. 4 and 5, as the disclosed methods are capable of being generalized to any model architecture by a person skilled in the art in view of the present disclosures. Text descriptions provided by a user, (e.g., prompts) can be processed with a text encoder to produce embedding vectors in the latent space (as an illustrative example) for each token in the prompt/text descriptions. The diffusion model can receive these token embeddings, (e.g., text description of what will be in the image) and process that information in a latent space iteratively over a predetermined quantity of steps, starting from random noise, in a reverse diffusion process. The latent diffusion model can be implemented as a U-Net, as an illustrative example. At each step, the model outputs latents. After the diffusion process, the resulting latent can be passed into an image decoder to generate a final image. An autoencoder decoder with several ResNet, up-sampling, and convolutional layers can take in latents to produce the final image(s). Decoding can be the final step of the image generation process and can take place once in some implementations.

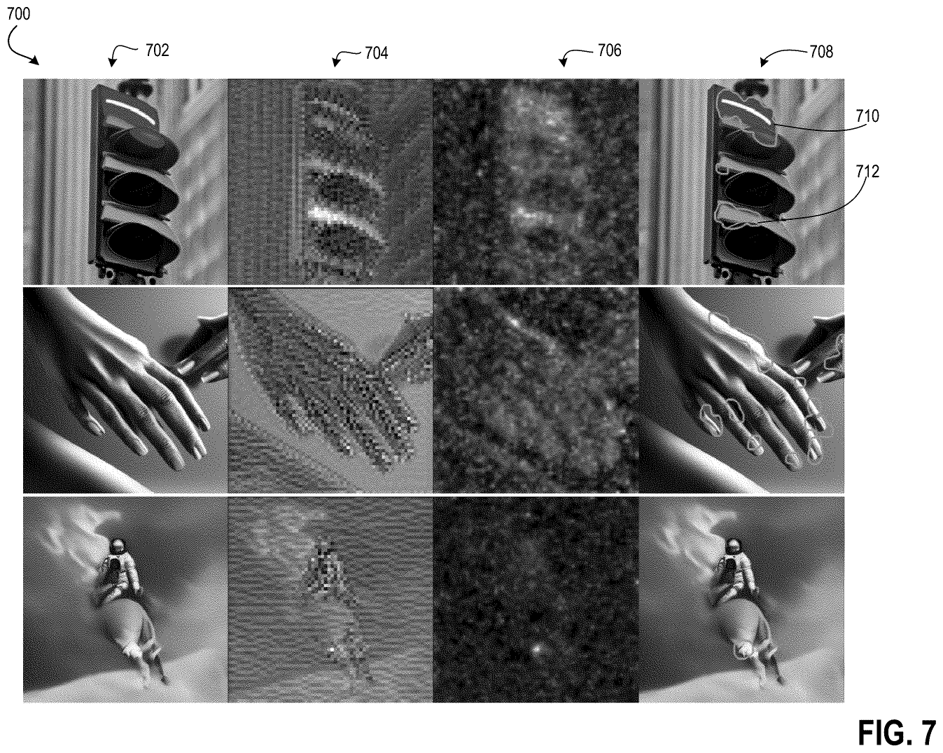

FIG. 7 is a table 700 illustrating example images with high-uncertainty regions from outputs of risk-aware stable diffusion model. As shown in the table 700, column 702 shows example generated images, column 704 shows an example latent diffusion state for each of the generated images of the column 702, column 706 shows example estimated pixel-wise uncertainty for each of the generated images of the column 702, and column 708 shows example highest-uncertainty thresholds over each of the generated images of the column 702. In the column 706, darker and lighter regions of the images show lower and higher uncertainty, respectively.

Prompting and sampling from the risk-aware stable diffusion model can be performed, and in turn the outputs and their associated uncertainties can be evaluated. Specifically, the pixel-wise uncertainty can be measured across inferred latents and decoded output. Computed pixel-wise scores can be used to estimate thresholds of highest uncertainty over the generated images.

Across challenging prompts (e.g., stoplights, human hands), regions estimated to have high uncertainty can correspond to semantically challenging, fallacious, and/or incorrect regions of the generated images. In the stoplight example of FIG. 7, for instance, high uncertainty scores can be found in some regions 710 and 712, where indicia, such as color, patterns, shapes, etc. may be misplaced. In the stoplight example of FIG. 7 in column 708, the regions 710 and 712 are represented in an indicia (e.g., color, pattern, shading, shape) that appears above respective bulbs of the stoplight. For example, region 710 can be a region of red light and region 712 can be a region of green light. The uncertainty scores are higher for the regions 710 and 712 because the regions 710 and 712 are not appropriately positioned where the respective bulbs of the stoplight would be. In the human hand example of FIG. 7, for example, targeted regions of high uncertainty can be identified around nails and extra fingers in the generated images. Moreover, in the example of an astronaut riding a horse in FIG. 7, the disclosed technology returns a single focal region of high uncertainty, which upon inspection corresponds to a region of the astronaut's spacesuit misplaced on the horse's leg. The results shown in the table 700 of FIG. 7 highlight the ability of the disclosed risk-aware techniques to identify semantically meaningful regions of high uncertainty in generated output images.

Computing System(s) for Use with Present Disclosures.

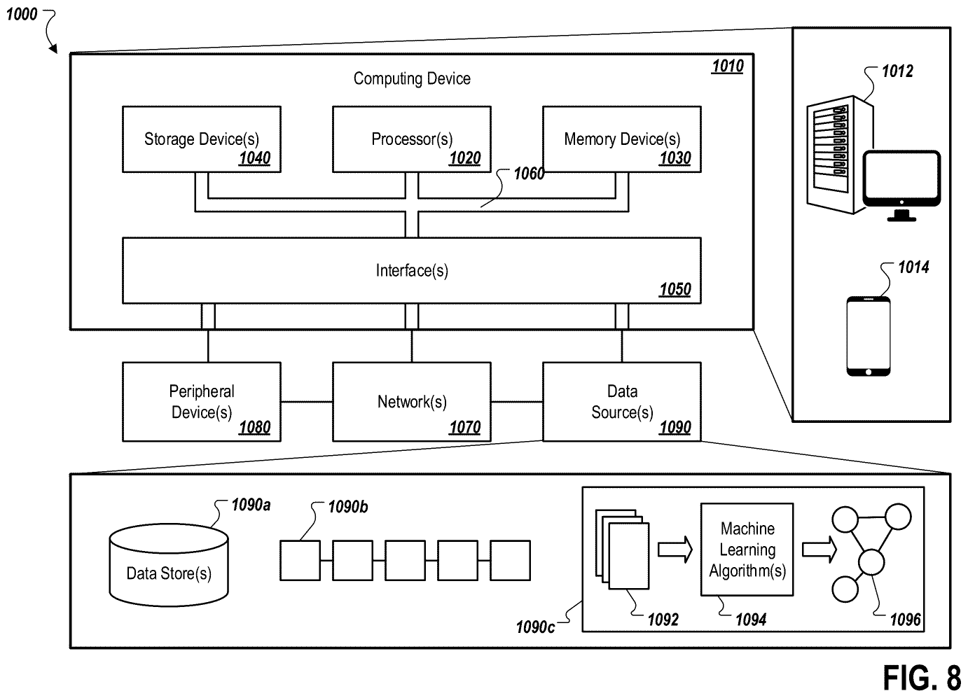

FIG. 8 is a schematic diagram that shows an example of a computing system 1000 that can be used to implement the techniques described herein. The computing system 1000 includes one or more computing devices (e.g., computing device 1010), which can be in wired and/or wireless communication with various peripheral device(s) 1080, data source(s) 1090, and/or other computing devices (e.g., over network(s) 1070). The computing device 1010 can represent various forms of stationary computers 1012 (e.g., workstations, kiosks, servers, mainframes, edge computing devices, quantum computers, etc.) and mobile computers 1014 (e.g., laptops, tablets, mobile phones, personal digital assistants, wearable devices, etc.). In some implementations, the computing device 1010 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1010, and an entire system can be made up of multiple devices communicating with each other. For example, the computing device 1010 can be part of a computing system that includes a network of computing devices, such as a cloud-based computing system, a computing system in an internal network, or a computing system in another sort of shared network. Processors of the computing device (1010) and other computing devices of a computing system can be optimized for different types of operations, secure computing tasks, etc. The components shown herein, and their functions, are meant to be examples, and are not meant to limit implementations of the technology described and/or claimed in this document.

The computing device 1010 includes processor(s) 1020, memory device(s) 1030, storage device(s) 1040, and interface(s) 1050. Each of the processor(s) 1020, the memory device(s) 1030, the storage device(s) 1040, and the interface(s) 1050 are interconnected using a system bus 1060. The processor(s) 1020 are capable of processing instructions for execution within the computing device 1010, and can include one or more single-threaded and/or multi-threaded processors. The processor(s) 1020 are capable of processing instructions stored in the memory device(s) 1030 and/or on the storage device(s) 1040. The memory device(s) 1030 can store data within the computing device 1010, and can include one or more computer-readable media, volatile memory units, and/or non-volatile memory units. The storage device(s) 1040 can provide mass storage for the computing device 1010, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1050 can include various communications interfaces (e.g., USB, Near-Field Communication (NFC), Bluetooth, WiFi, Ethernet, wireless Ethernet, etc.) that can be coupled to the network(s) 1070, peripheral device(s) 1080, and/or data source(s) 1090 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1050 can include a control interface that receives commands from an input device (e.g., operated by a user) and converts the commands for submission to the processors 1020. The interface(s) 1050 can include a display interface that includes circuitry for driving a display to present visual information to a user. The interface(s) 1050 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1070 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1010 can communicate with the peripheral device(s) 1080, the data source(s) 1090, and/or other computing devices over the network(s) 1070. In some implementations, the computing device 1010 can directly communicate with the peripheral device(s) 1080, the data source(s), and/or other computing devices.

The peripheral device(s) 1080 can provide input/output operations for the computing device 1010. Input devices (e.g., keyboards, pointing devices, touchscreens, microphones, cameras, scanners, sensors, etc.) can provide input to the computing device 1010 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1010 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1090 can provide data for use by the computing device 1010, and/or can maintain data that has been generated by the computing device 1010 and/or other devices (e.g., data collected from sensor devices, data aggregated from various different data repositories, etc.). In some implementations, one or more data sources can be hosted by the computing device 1010 (e.g., using the storage device(s) 1040). In some implementations, one or more data sources can be hosted by a different computing device. Data can be provided by the data source(s) 1090 in response to a request for data from the computing device 1010 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1090a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1090b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1090c. The machine learning system(s) 1090c, for example, can be used to analyze data from various sources (e.g., data provided by the computing device 1010, data from the data store(s) 1090a, data from the blockchain(s) 1090b, and/or data from other data sources), to identify patterns in the data, and to draw inferences from the data patterns. In general, training data 1092 can be provided to one or more machine learning algorithms 1094, and the machine learning algorithm(s) can generate a machine learning model 1096. Execution of the machine learning algorithm(s) can be performed by the computing device 1010, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

The invention claimed is:

1. A method for modifying an input for a generative machine learning model, the method comprising:
receiving a user model and an input;
transforming the user model into a risk-aware model;
applying the risk-aware model to the input;
receiving, based on the applying risk-aware model, output and corresponding risk values;
determining whether the corresponding risk values, or an aggregate thereof, are less than a predetermined threshold level;
in response to determining that the corresponding risk values, or aggregate thereof, are greater than the predetermined threshold level, performing a process to modify the input to minimize the corresponding risk values; and
iteratively applying the risk-aware model to the modified input and performing the process to modify the input until the corresponding risk values are less than the predetermined threshold level.

2. The method of claim 1, wherein performing the process to modify the input to minimize the corresponding risk values comprises computing a risk estimate for use in guiding an algorithm used to perform the process to modify the input.

3. The method of claim 2, wherein performing the process to modify the input to minimize the corresponding risk values further comprises:
initializing a current input from the input;
defining a set of inputs to be used as base text for the current input;
defining a list of operations that are able to be performed on a given input;
receiving a previous input and previously computed risk estimate;
if the computed risk estimate is higher than the previously computed risk estimate, then using the previous input as the current input; and
sampling one or more operations of the defined list of operations to modify the current input.

4. The method of claim 1, wherein performing the process to modify the input to minimize the corresponding risk values comprises computing a gradient of risk indicating a numeric vector of how to modify the input to achieve lower corresponding risk values.

5. The method of claim 4, wherein the gradient of risk is computed with respect to an initial state of the input.

6. The method of claim 4, wherein performing the process further comprises applying the gradient of risk to the input to modify the input.

7. The method of claim 4, wherein performing the process further comprises:
providing the input, the computed gradient of risk, and modeling conditions to a learned model; and
receiving, as output from the learned model, the modified input.

8. The method of claim 7, wherein the learned model was trained to modify at least one of image inputs, video inputs, or audio inputs based on respective modeling conditions.

9. The method of claim 1, wherein in response to determining that the corresponding risk values, or aggregate thereof, are less than the predetermined threshold level, the method comprises returning the model output.

10. The method of claim 1, wherein the machine learning model is a generative neural network.

11-23. (canceled)

24. A method for modifying an input for a machine learning model, the method comprising:
receiving model output and corresponding risk values, wherein the model output and corresponding risk values were generated by a model in response to receiving user input;
determining whether the corresponding risk values are less than a predetermined threshold value;
in response to determining that the corresponding risk values are greater than the predetermined threshold value, computing a risk estimate;
modifying the user input based on the computed risk estimate; and
returning the modified user input.

25. The method of claim 24, wherein modifying the user input based on the computed risk estimate comprises iteratively providing the modified input to the model until the corresponding risk values are less than the predetermined threshold value.

26. The method of claim 24, wherein modifying the user input based on the computed risk estimate comprises at least one of:
initializing a current input from the user input;
defining a set of inputs to be used as base text for the current input;
defining a list of operations that are able to be performed on a given input;
receiving a previous input and previously computed risk estimate;
if the computed risk estimate is higher than the previously computed risk estimate, then using the previous input as the current input; and
sampling one or more operations of the defined list of operations to modify the current input.

27-32. (canceled)

33. A system for modifying an input for a machine learning model, the system comprising:
a computer system comprising one or more processors and memory configured to store instructions that, when executed by the one or more processors, cause the computer system to perform a process comprising:
receiving a user model and an input;
transforming the user model into a risk-aware model;
applying the risk-aware model to the input;
receiving, based on the applying, model output and corresponding risk values;
determining whether the corresponding risk values are less than a predetermined threshold level;
in response to determining that the corresponding risk values are greater than the predetermined threshold level, performing a process to modify the input to minimize the corresponding risk values; and
iteratively applying the risk-aware model to the modified input until the corresponding risk values are less than the predetermined threshold level.

34. The system of claim 33, wherein performing the process to modify the input to minimize the corresponding risk values comprises computing a risk estimate for use in guiding an algorithm used to perform the process to modify the input.

35. The system of claim 34, wherein performing the process to modify the input to minimize the corresponding risk values further comprises:
initializing a current input from the input;
defining a set of inputs to be used as base text for the current input;
defining a list of operations that are able to be performed on a given input;
receiving a previous input and previously computed risk estimate;
if the computed risk estimate is higher than the previously computed risk estimate, then using the previous input as the current input; and
sampling one or more operations of the defined list of operations to modify the current input.

36. The system of claim 33, wherein performing the process to modify the input to minimize the corresponding risk values comprises computing a gradient of risk indicating a numeric vector of how to modify the input to achieve lower corresponding risk values.

37. The system of claim 36, wherein the gradient of risk is computed with respect to an initial state of the input.

38. The system of claim 36, wherein performing the process to modify the input to minimize the corresponding risk values comprises applying the gradient of risk to the input to modify the input.

39. The system of claim 33, wherein in response to determining that the corresponding risk values are less than the predetermined threshold level, the process performed by the computer system further comprises returning the model output.

40-54. (canceled)
